(19) United States
(12) Patent Application Publication
(10) Pub. No.: US 2014/0285504 A1
(43) Pub. Date: Sep. 25, 2014

(54) CONTROLLABLE DISPLAY APPARATUS AND APPLICATIONS THEREOF

(71) Applicant: AU OPTRONICS CORPORATION, Hsinchu (TW)

(72) Inventors: Yi-Chun Lin, Hsinchu (TW); Chien Hung Chen, Hsinchu (TW)

(73) Assignee: AU Optronics Corporation, Hsinchu (TW)

(21) Appl. No.: 13/848,600

(22) Filed: Mar. 21, 2013

(51) Int. Cl. G06T 1/60; G09G 3/36

(52) U.S. Cl. CPC G06T 1/60; G09G 3/3611
USPC 345/530; 345/87

(57) ABSTRACT

Aspects of the invention relate to a controllable display apparatus and applications thereof. The controllable display storage includes a storage having a storage space therein and an opening exposing the storage space to an outer environment, a transparent display panel disposed at the opening, configured to display information thereon, a control device disposed between a part of the storage space and the transparent display panel, where at least a part of the control device is switchable between a transparent mode and an opaque mode, such that the information displayed on the transparent display panel is viewable when the control device is in the opaque mode, and an item displayed in the storage space is viewable through the transparent display panel when the control device is in the transparent mode, and at least one light source disposed in the storage space to provide light to the storage space.

### FIELD OF THE DISCLOSURE

The disclosure relates generally to display technology, and more particularly to controllable display apparatuses and applications thereof.

### BACKGROUND OF THE DISCLOSURE

Display windows, cabinets and boxes are widely used as the instruments for advertising and displaying business products. For example, merchants and restaurant owners may put their products, goods and food samples in a display window such that customers who see the products may be attracted. Generally, a transparent cover, such as glass or plastic materials, is provided to cover the display window to avoid the customers touching or taking away the items displayed therein. Further, a sign may also be provided in the display window to describe the items. To increase the versatility of the description of the items, a transparent display panel may be used to provide the dual functions of the transparent cover and the sign. Thus, the transparent display panel may dynamically show information of the items displayed and other information desired by the merchant, and the customers may see through the transparent display panel to view the items displayed and the information at the same time. The information displayed may be in the forms of textures, images, dynamic slides, video streams or other types of information.

However, the customers may see the display windows from different viewpoints or angles. From certain angles, the information may overlap the items displayed behind the transparent display panel. Thus, in some occasions, the overlapping information may be dazzling such that the customers would have problems identifying the information displayed on the transparent display panel or observing the items displayed behind the transparent display panel. Specifically, when the information displayed on the transparent display panel and the overlapping items are in a similar color, or when the items are in multiple colors, the customers would have difficulties recognizing the information, thus damaging the advertising effects.

Therefore, a heretofore unaddressed need exists in the art to address the aforementioned deficiencies and inadequacies.

### SUMMARY OF THE DISCLOSURE

In one aspect, the disclosure relates to a controllable display storage. In one embodiment, the controllable display storage includes: a storage having a storage space therein and an opening exposing the storage space to an outer environment, a transparent display panel disposed at the opening, defining a viewer side facing the outer environment and a control side facing the storage space, configured to display information thereon, a control device disposed at the control side of the transparent display panel between at least a part of the storage space and the transparent display panel, wherein at least a part of the control device is switchable between a plurality of control modes, wherein the plurality of control modes includes a transparent mode and an opaque mode.

In one embodiment, the controllable display storage is a display window, a display box or a display cabinet.

In one embodiment, the controllable display storage further includes: at least one light source disposed in the storage space to provide light to the storage space.

In one embodiment, the control device includes an electrically controlled liquid crystal glass or an electrically controlled liquid crystal film. In a further embodiment, the plurality of control modes further includes a semi-transparent mode such that the information displayed on the transparent display panel and the item at the control side are concurrently viewable from the viewer side when the control device is in the semi-transparent mode. In a further embodiment, the control device includes a plurality of control regions thereon, wherein each control region is individually switchable between the plurality of control modes.

In one embodiment, the control device is a screen movable between a first position and a second position, wherein the control device is in the transparent mode when the control device moves to the first position, and in the opaque mode when the control device moves to the second position. In a further embodiment, the controllable display storage further includes: at least one roller motor connected to the control device for moving the control device between the first position and the second position.

In one embodiment, the control device corresponds to at least a portion of the transparent display panel.

In another aspect, the disclosure relates to a controllable display storage. In one embodiment, the controllable display storage includes: a storage having a storage space therein and at least one opening exposing the storage space to an outer environment, at least one controllable display apparatus disposed at the at least one opening, respectively, and at least one light source disposed in the storage space to provide light to the storage space. Each controllable display apparatus includes: a transparent display panel defining a viewer side and a control side facing the storage space, configured to display information thereon, and a control device disposed at the control side of the transparent display panel between at least a part of the storage space and the transparent display panel, wherein at least a part of the control device is switchable between a plurality of control modes, wherein the plurality of control modes includes a transparent mode and an opaque mode, such that the information displayed on the transparent display panel is viewable from the viewer side when the control device is in the opaque mode, and an item displayed in the storage space is viewable from the viewer side through the transparent display panel when the control device is in the transparent mode.

In one embodiment, the controllable display storage further includes at least one light source disposed in the storage space to provide light to the storage space.

In one embodiment, the control device includes an electrically controlled liquid crystal glass or an electrically controlled liquid crystal film. In a further embodiment, the control device includes a plurality of control regions thereon, wherein each control region is individually switchable between the plurality of control modes.

In one embodiment, the control device is a screen movable between a first position and a second position, wherein the control device is in the transparent mode when the control device moves to the first position, and in the opaque mode when the control device moves to the second position. In a further embodiment, the controllable display storage further includes: at least one roller motor connected to the control device for moving the control device between the first position and the second position.

In one embodiment, the control device corresponds to at least a portion of the transparent display panel.

Another aspect of the disclosure relates to a controllable display apparatus, which includes: a transparent display panel defining a viewer side and a control side, configured to display information thereon, and a control device disposed at the control side of the transparent display panel, wherein at least a part of the control device is switchable between a plurality of control modes, wherein the plurality of control modes includes a transparent mode and an opaque mode, such that the information displayed on the transparent display panel is viewable from the viewer side when the control device is in the opaque mode, and an item at the control side is viewable from the viewer side through the transparent display panel when the control device is in the transparent mode.

In one embodiment, the control device includes an electrically controlled liquid crystal glass or an electrically controlled liquid crystal film. In a further embodiment, the plurality of control modes further includes a semi-transparent mode such that the information displayed on the transparent display panel and the item at the control side are concurrently viewable from the viewer side when the control device is in the semi-transparent mode. In a further embodiment, the control device includes a plurality of control regions thereon, wherein each control region is individually switchable between the plurality of control modes.

In one embodiment, the control device corresponds to at least a portion of the transparent display panel.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 shows schematically a cross-sectional side view of a controllable display storage according to one embodiment of the disclosure;

FIG. 2 shows schematically an exploded view of a controllable display storage according to one embodiment of the disclosure;

FIG. 3A shows schematically a controllable display storage according to one embodiment of the disclosure, where the control device is in an opaque mode;

FIG. 3B shows schematically a controllable display storage according to one embodiment of the disclosure, where the control device is in a transparent mode;

FIG. 3C shows schematically a controllable display storage according to one embodiment of the disclosure, where the control device is in a semi-transparent mode;

FIGS. 4A-4E show schematically controllable display storages having control devices with different shapes or positions according to embodiments of the disclosure;

FIGS. 5A-5E show schematically controllable display storages controlled by roller motors according to embodiments of the disclosure;

FIGS. 6A-6D show schematically display of the controllable display apparatus of a controllable display storage according to embodiments of the disclosure; and

FIG. 7 shows schematically a perspective view of a controllable display storage according to one embodiment of the disclosure.

### DETAILED DESCRIPTION OF THE DISCLOSURE

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top”, and “left” and “right”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

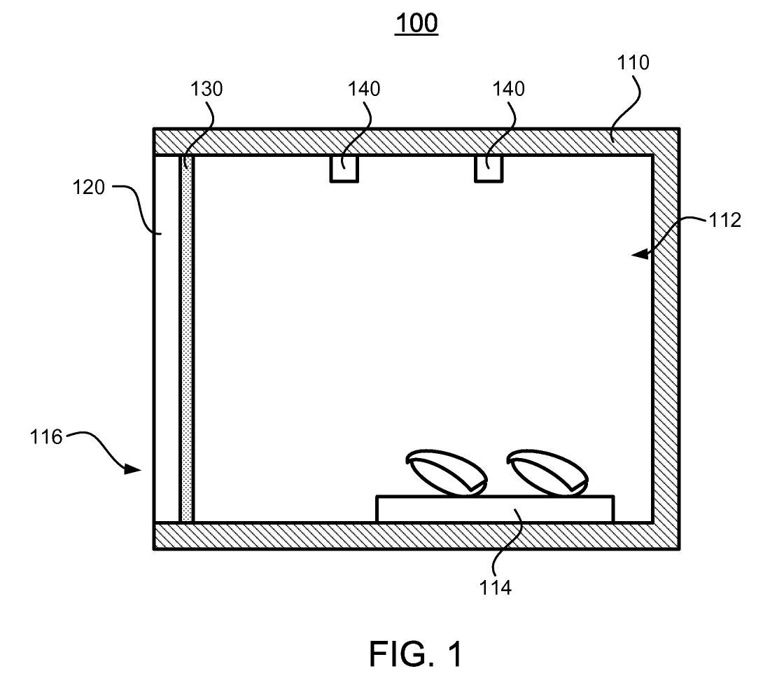

The description will be made as to the embodiments of the present disclosure in conjunction with the accompanying drawings in FIGS. 1-7. In accordance with the purposes of this disclosure, as embodied and broadly described herein, this disclosure, in one aspect, relates to a controllable display apparatus and applications thereof. An application of the controllable display apparatus is for the use of a controllable display storage, such that the controllable display storage may switchably display the items stored in the storage or the information displayed on the controllable display apparatus. Examples of the controllable display storage may include a display window, a display box, a display cabinet, or other types of display storages. For example, a restaurant may use display boxes for displaying food samples to the customers. A jewelry store may put rings, necklaces, cufflinks and other decorating jewelry in a display cabinet. In a pet store, display windows may be used for storing and displaying large sized animals, and display boxes may be used for displaying small sized animals.

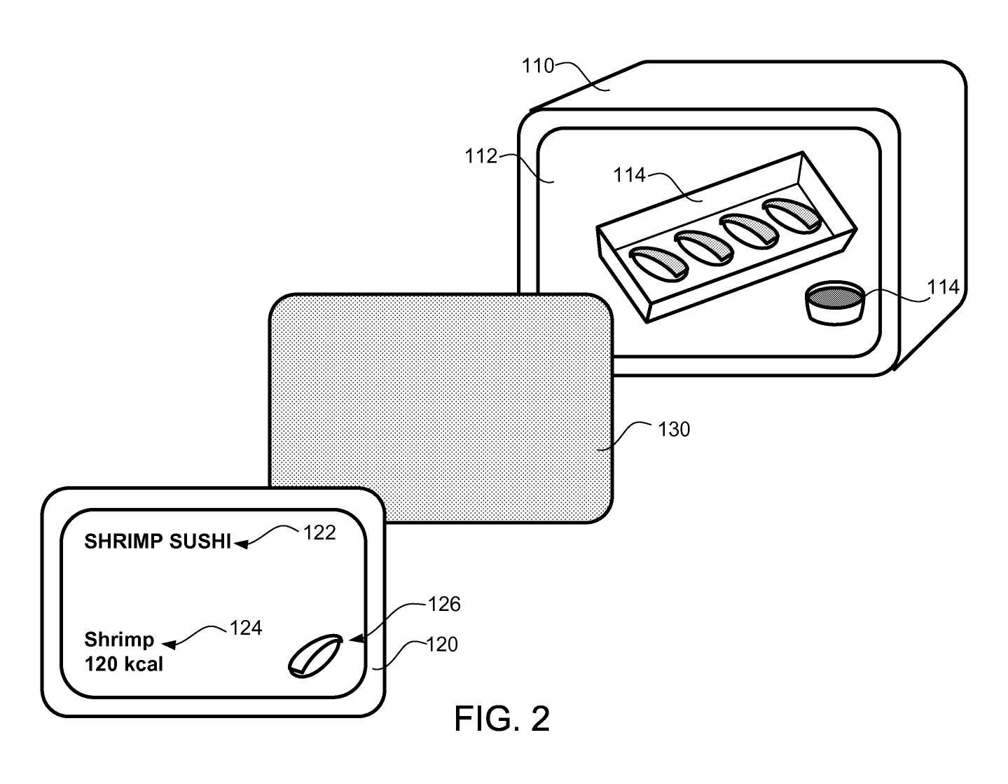

FIGS. 1 and 2 respectively show schematically a controllable display storage according to one embodiment of the disclosure, where FIG. 1 shows a cross-sectional side view, and FIG. 2 shows an exploded view. As shown in FIGS. 1 and 2, the controllable display storage 100 is a display box for a restaurant, and a sushi meal sample, including a sushi plate and a bowl, is stored in the display box as the items 114 to be displayed. The controllable display storage includes a storage 110, a transparent display panel 120, a control device 130, and two light sources 140. The transparent display panel 120 and the control device 130 form a controllable display apparatus.

The storage 110 is provided for storing items 114 to be displayed. Specifically, the storage 110 has a storage space 112 therein for storing the items (the sushi plate and the bowl) 114 to be displayed, and an opening 116 (on the left side of FIG. 1) exposing the storage space 112 to an outer environment. The size, dimension or shape of the storage space 112 and the opening 116 may be properly determined such that the items 114 displayed are capable of being stored in the storage space 112. In certain embodiments, the storage 110 may have a gate which is openable such that a user may open the gate to put the item 114 in the storage space 112 or to take out the item 114 from the storage space 112.

The transparent display panel 120 is a display panel for displaying information thereon, which is transparent such that contents behind the transparent display panel 120 is generally viewable through the transparent display panel 120. As shown in FIG. 1, the transparent display panel 120 is disposed at the opening 116 of the storage 110, and the transparent display panel 120 defines a viewer side (the left side of FIG. 1) facing the outer environment and a control side (the right side of FIG. 1) facing the storage space 112. As shown in FIG. 2, a plurality of information is displayed on the transparent display panel 120, including the texts “SHRIMP SUSHI” 122 on the upper left side, the texts “Shrimp 120 kcal” 124 on the bottom left side, and a sushi picture 126 on the bottom right side, as the description of the items 114 displayed in the storage space 112. The size and shape of the transparent display panel 120 may be corresponding to the size and shape of the opening 116. In certain embodiments, the transparent display panel 120 may be fixed to the opening 116.

The control device 130 is disposed at the control side of the transparent display panel 120 (the right side of FIG. 1), facing the storage space 112. As shown in FIG. 1, the control device 130 is disposed between the storage space 112 and the transparent display panel 120. In this exemplary embodiment, the control device 130 is attached to the transparent display panel 120. In certain embodiments, the control device 130 is an electrically controlled liquid crystal glass or an electrically controlled liquid crystal film, which may be switchable between a plurality of control modes, such as an opaque mode, a transparent mode and a semi-transparent mode.

The light sources 140 are disposed in the storage space 112 to provide light to the storage space 112 such that the item 114 to be displayed in the storage space 112 is clearly viewable to the customer. In certain embodiments, the light sources 140 may be light bulbs, light emitting diodes or any other light emitting devices. The number and position of the light sources 140 in the storage space 112 are not specifically limited. In one embodiment, for example, the storage 110 may be provided with only one light source 140.

It should be appreciated that, as shown in FIGS. 1 and 2, the controllable display storage 100 does not include a backlight module or a backlight device. Instead, light in the storage space 112 is provided by the light sources 140 or light from outside environment. Thus, the transparent display panel 120 would have better performances in optical penetration and transmittance.

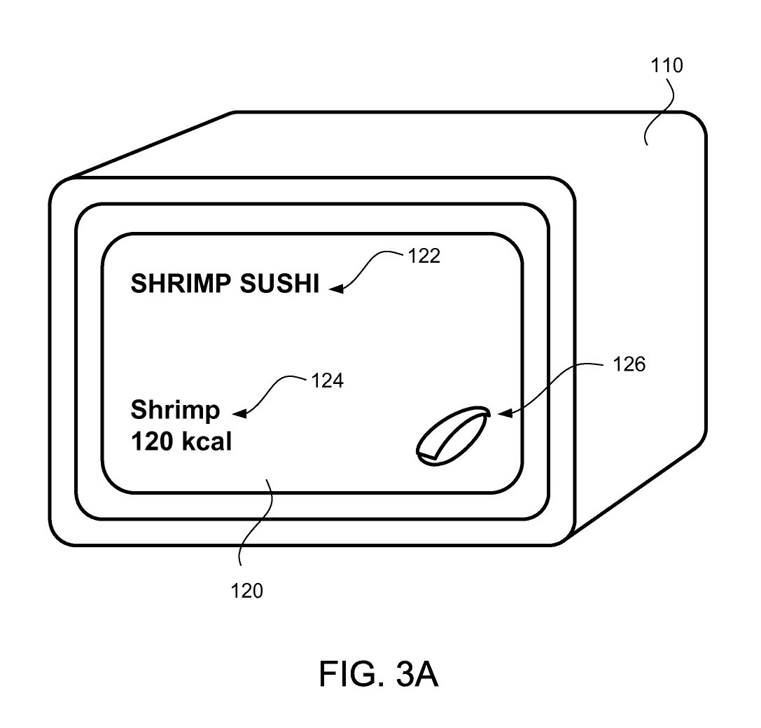

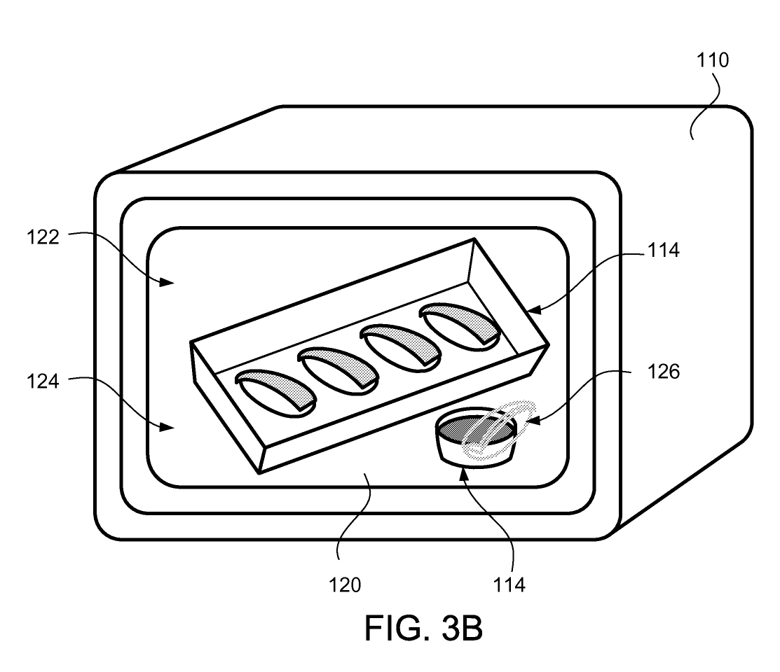

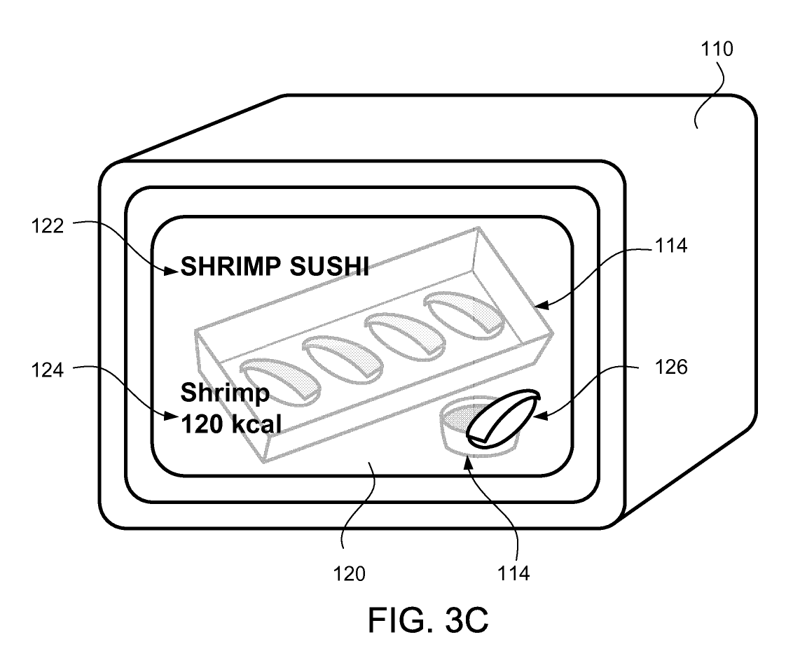

The control modes of the control device 130 may be further described with respect to FIGS. 3A-3C. As shown in FIG. 3A, the control device 130 may be in the opaque mode, such that the control device 130 would be opaque to hide the items 114 displayed in the storage space 112 such that the information 122, 124 and 126 displayed on the transparent display panel 120 would be viewable from the viewer side of the transparent display panel 120. On the other hand, when the control device 130 is in the transparent mode, as shown in FIG. 3B, the transparent control device 130 would allow the items 114 displayed in the storage space 112 to be viewable from the viewer side through the transparent display panel 120. Further, the control device 130 may be controlled to be in the semi-transparent mode, as shown in FIG. 3C, such that both the information 122, 124 and 126 displayed on the transparent display panel 120 and the items 114 displayed in the storage space 112 are concurrently viewable from the viewer side of the transparent display panel 120. Accordingly, by controlling the control device 130 to randomly or periodically switch between the plurality of control modes, the customers may alternatively see the information and the items clearly, thus achieving the advertising of the items.

As described above, in certain embodiments, the control device 130 may be an electrically controlled liquid crystal glass or an electrically controlled liquid crystal film. Thus, the switching between the plurality of control modes may be achieved by controlling the input voltage of the control device 130 to change the orientation of the liquid crystal cells thereof. In one embodiment, for example, the control device 130 may be an electrically controlled liquid crystal film having a liquid crystal layer filled with liquid crystal cells. When the input voltage is a high voltage, such as 65V, the liquid crystal layer has the highest optical transmission rate such that the control device 130 is in the transparent mode. When the input voltage is zero (in other words, no input voltage is applied), the liquid crystal layer has the lowest optical transmission rate such that the control device 130 is in the opaque mode. When the input voltage is a low voltage, such as 30V, the liquid crystal layer has an optical transmission rate between the highest rate and the lowest rate such that the control device 130 is in the semi-transparent mode. But the input voltage is not limited to, it depends on a sort of the liquid crystal layers or a kind of the control devices.

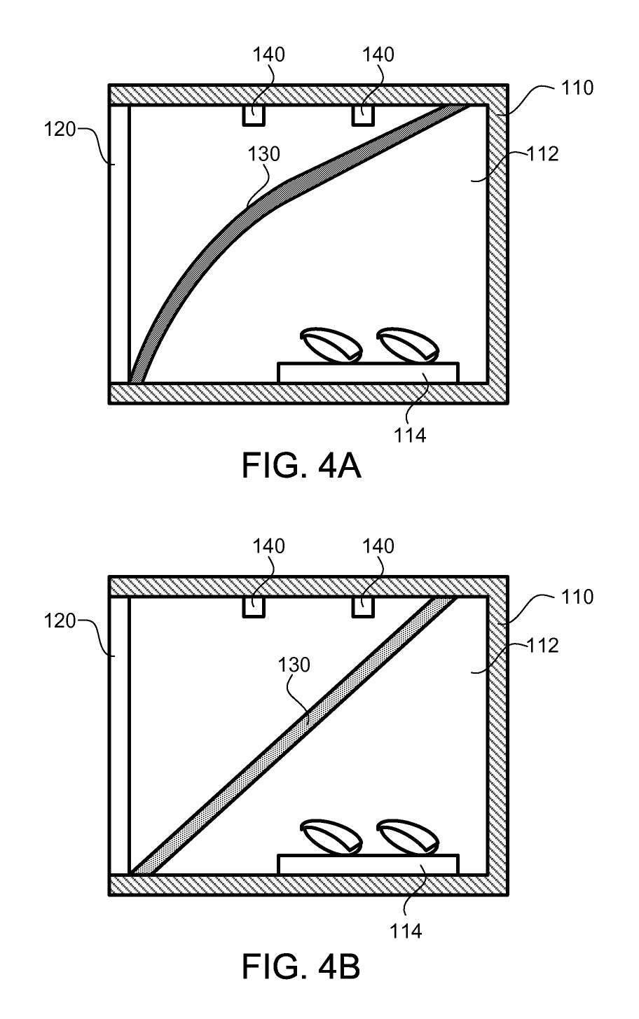

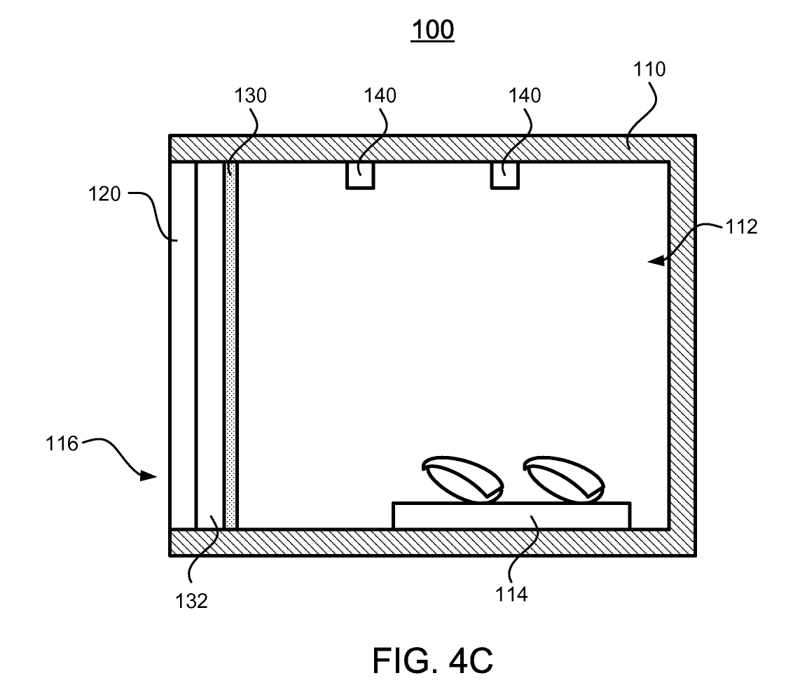

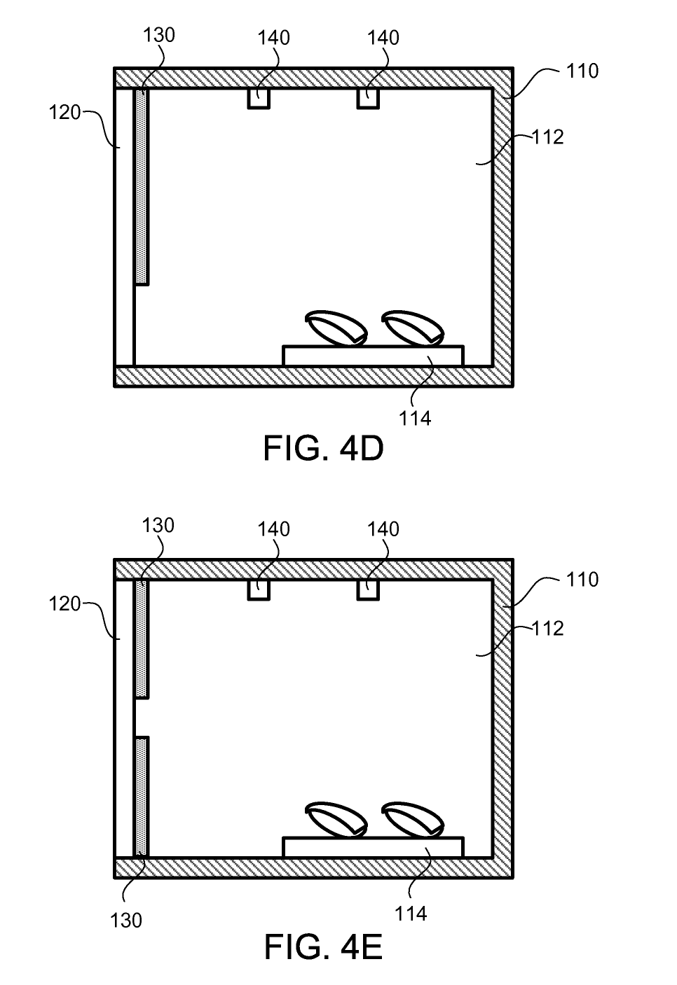

It should be appreciated that the size, shape and position of the control device 130 may be varied to be corresponding to the storage space 112, the position of the light sources 140, and the items 114 displayed in the storage space 112. Specifically, the control device 130 is disposed at the control side of the transparent display panel between at least a part of the storage space 112 and the transparent display panel 120 such that the part of the storage space 112 is capable of storing the items 114 to be displayed. For example, FIG. 4A shows a controllable display storage according to one embodiment of the disclosure, where the control device 130 is bended in a curved shape. FIG. 4B shows a controllable display storage according to another embodiment of the disclosure, where the control device 130 is disposed in a slant position. In certain embodiments, the curved or slant position of the control device 130 would increase the total optical transmission rate of the transparent display panel 120 and the control device 130 such that the items 114 would be clearly displayed when the control device 130 is in the transparent mode. FIG. 4C shows a controllable display storage according to a further embodiment of the disclosure, where the control device 130 is parallely disposed to the transparent display panel 120, defining a gap 132 between the transparent display panel 120 and the control device 130 such that the transparent display panel 120 and the control device 130 may be individually and separately installed or detached without affecting the other structures. FIG. 4D shows a controllable display storage according to yet another embodiment of the disclosure, where the control device 130 is disposed to correspond to only the top portion of the transparent display panel 120, and the bottom portion of the transparent display panel 120 does not correspond to the control device 130. That is, the area of the transparent display panel 120 is larger than that of the control device 130. FIG. 4E shows a controllable display storage according to a further embodiment of the disclosure, where the control device 130 is disposed to correspond to the top and bottom portions of the transparent display panel 120, and the middle portion of the transparent display panel 120 does not corresponds to the control device 130. In each embodiment, the items 114 may be stored in the part of the storage space 112 at the opposite side of the control device 130 to the transparent display panel 120 without being interfered by the control device 130.

As described above, in one embodiment, the control device may be electrically controllable to switch between the plurality of control modes. However, in some other embodiments, the control device may be a movable screen having transparent and opaque areas, such that the control device may be switchable between the control modes by moving the control device.

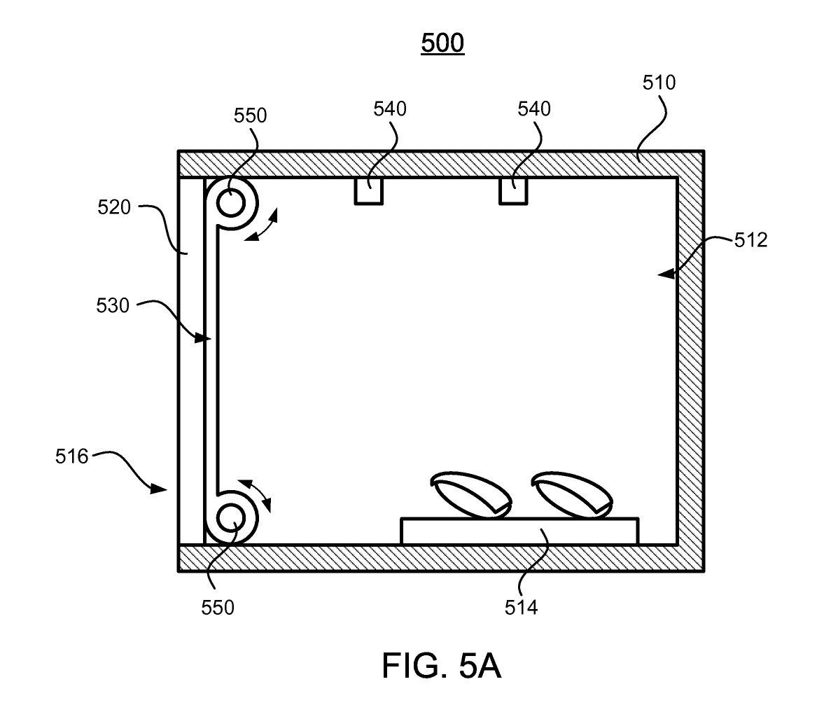

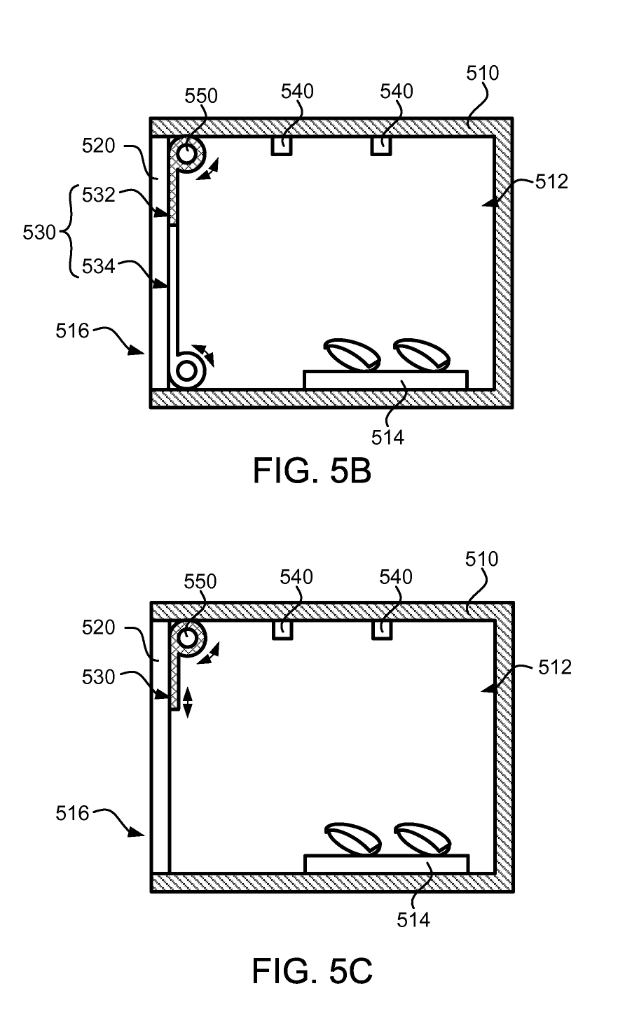

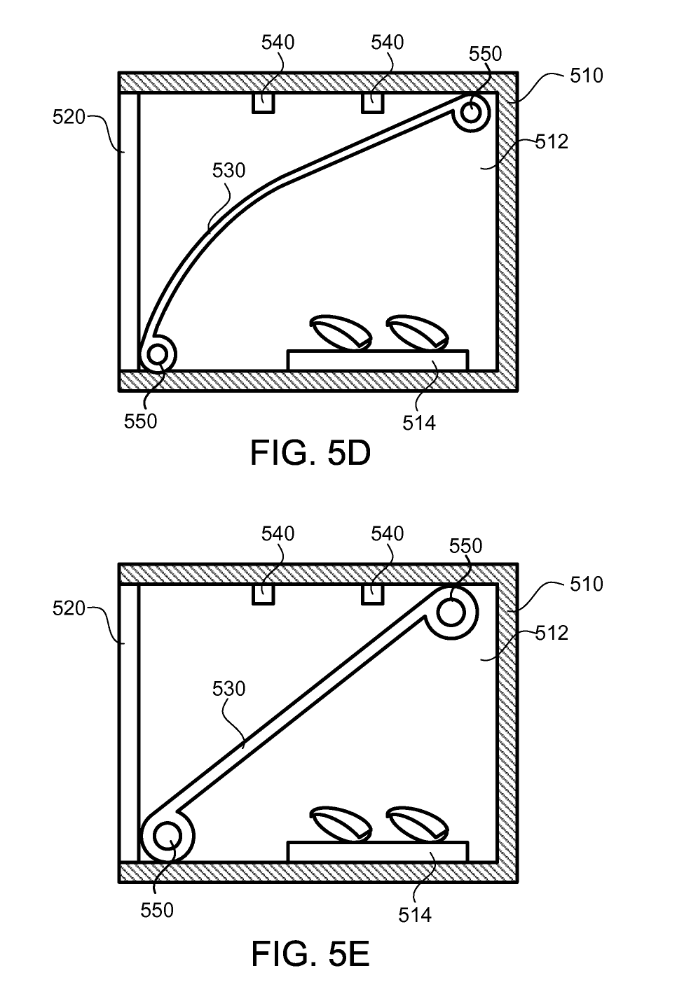

FIG. 5A shows schematically a controllable display storage controlled by roller motors according to one embodiment of the disclosure. As shown in FIG. 5A, the controllable display storage 500 includes a storage 510, a transparent display panel 520, a control device 530, and two light sources 540, which are essentially the same elements as the controllable display storage 100 as shown in FIG. 1. The only difference exists in that the controllable display storage 500 includes two roller motors 550, which are respectively connected to the top and bottom edges of the control device 530. Thus, by controlling the roller motors 550, the control device 530 may be moved in a vertical direction such that the control modes may be switchable by moving the control device 530.

FIG. 5B shows schematically a controllable display storage controlled by roller motors according to another embodiment of the disclosure. The control device 530 may be a screen which includes at least an opaque area 532 and a transparent area 534, and the material of the screen may be a soft material such as clothes, plastic films, any other shielding or reflective materials, or a combination thereof. Specifically, the opaque area 532 includes the top half of the screen, and the transparent area 534 includes the bottom half of the screen. The two roller motors 550 are attached to the two ends of the control device 530 such that the control device 530 maintains flat in the vertical direction, and the roller motors 550 may be concurrently or individually controlled such that the control device 530 is movable vertically. When one of the roller motors 550 (the top roller motor 550) rolls in the clockwise direction to move the control device 530 upwards until all the opaque area 532 is around the top roller motor 550, the control device 530 is in a first position, and the transparent area 534 of the control device 530 would correspond to the transparent display panel 520. Thus, the control device 530 is in the transparent mode when the control device 530 moves to the first position. On the other hand, when the other of the roller motors 550 (the bottom roller motor 550) rolls in the counter-clockwise direction to move the control device 530 downwards until all of the transparent area 534 is around the bottom roller motor 550, the control device 530 is in a second position, and the opaque area 532 of the control device 530 would correspond to the transparent display panel 520. Thus, the control device 530 is in the opaque mode when the control device 530 moves to the second position.

FIG. 5C shows schematically a controllable display storage controlled by one roller motor according to yet another embodiment of the disclosure. In this embodiment, only one roller motor 550 is provided, and the structure of the controllable display storage is simplified from the control able display storage as shown in FIG. 5B. In this embodiment, the control device 530 may be an opaque screen, and only one roller motor 550 is provided to move the control device 530 in the vertical direction. The material of the screen may be a hardened material such as plastic films, any other shielding or reflective materials, or a combination thereof. When the roller motor 550 rolls in the clockwise direction to move the control device 530 upwards to a first position, the control device 530 would not correspond to the transparent display panel 520 such that the transparent mode is achieved. On the other hand, when the roller motor 550 rolls in the counter-clockwise direction to move the control device 530 downwards to a second position, the control device 530 would correspond to the transparent display panel 520 such that the opaque mode is achieved. In certain embodiments, the roller motor 550 may rotate to move the control device 530 to a middle position between the first and second positions such that the control device 530 corresponds to a part of the transparent display panel 520.

FIGS. 5D and 5E show controllable display storages controlled by roller motors according to other embodiments of the disclosure. The embodiment as shown in FIG. 5D is similar to the embodiment as shown in FIG. 4A, where the control device 530 is bended in a curved shape, and two roller motors 550 are provided to be connected to the top and bottom edges of the control device 530. The embodiment as shown in FIG. 5E is similar to the embodiment as shown in FIG. 4B, where the control device 530 is disposed in a slant position, and two roller motors 550 are provided to be connected to the top and bottom edges of the control device 530. Thus, by controlling the roller motors 550, the control device 530 may be moved along its contour such that the control modes may be switchable by moving the control device 530.

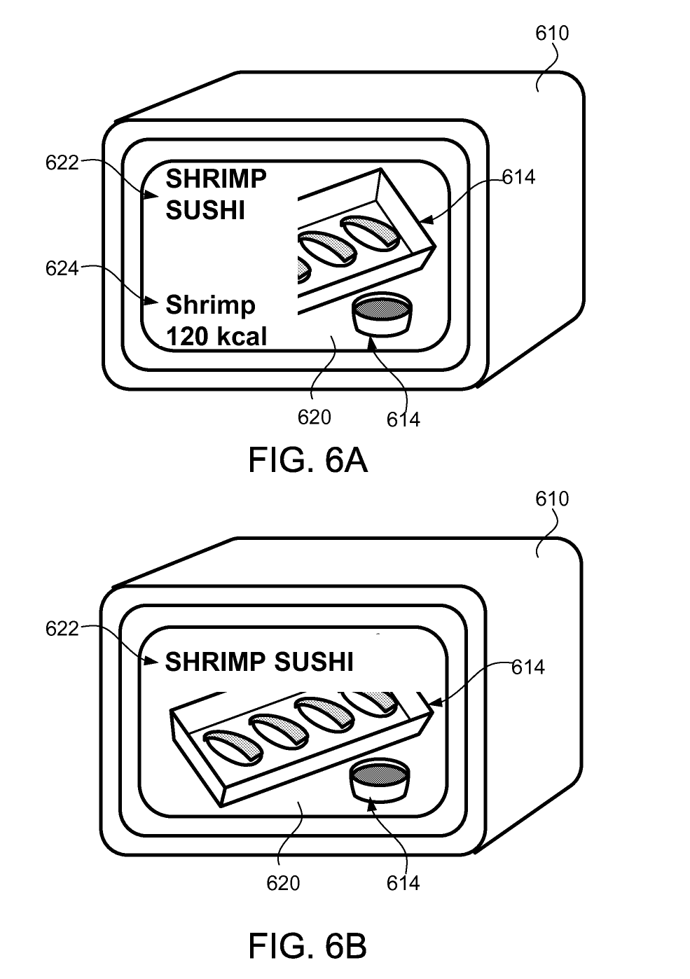

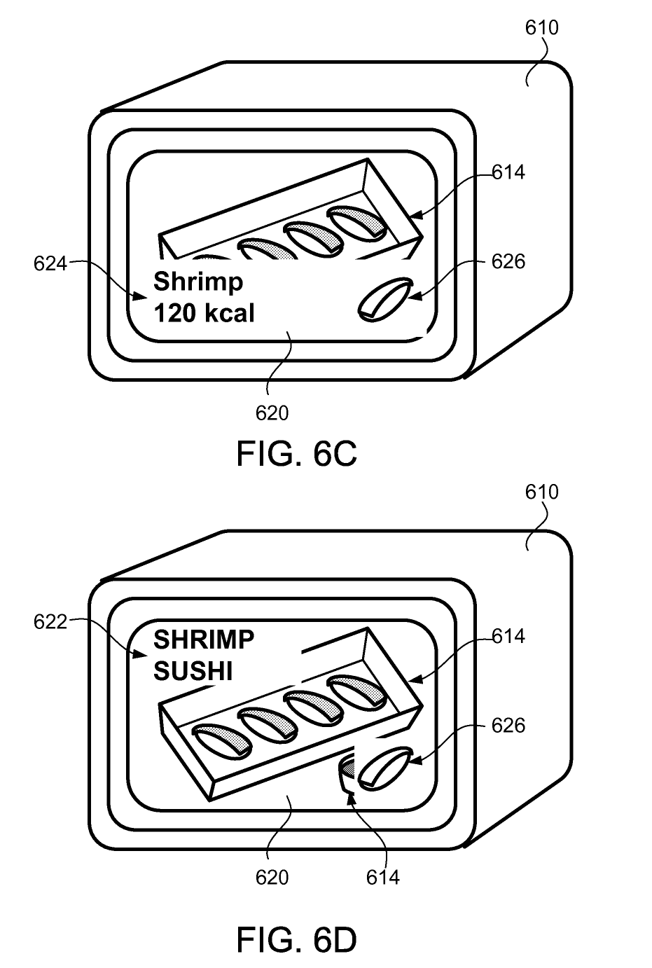

It should be appreciated that, in any of the embodiments of the control display storages where the control device may be electrically controllable to switch between the plurality of control modes, the control device may be controlled as a whole, or may include a plurality of control regions thereon such that each control region may be individually controlled. In one embodiment, when the control device is an electrically controlled liquid crystal glass or an electrically controlled liquid crystal film, the plurality of control regions may be achieved by controlling different regions of the liquid crystal layer separately with array electrodes, such that the orientation of the liquid crystal cells in each control region is different. In another embodiment, when the control device is a movable screen having transparent and opaque areas, the control device may be moved to a position where both the transparent and opaque areas correspond to the transparent display panel. For example, FIGS. 6A-6D show schematically display of the controllable display apparatus of a controllable display storage according to embodiments of the disclosure. As shown in FIG. 6A, the control device (not shown) is controlled such that the left part of the control device is in the opaque mode and the right part of the control device is in the transparent mode. Thus, the customer may see the information (texts) 622 and 624 on the left side of the transparent display panel 620, and the items 614 (the right half of the sushi plate and the bowl) on the right side of the transparent display panel 620. As shown in FIG. 6B, the control device (not shown) is controlled such that the top part of the control device is in the opaque mode and the bottom part of the control device is in the transparent mode. Thus, the customer may see the information (text) 622 on the top side of the transparent display panel 620, and the items 614 (the bottom half of the sushi plate and the bowl) on the bottom side of the transparent display panel 620. Specifically, the display as shown in FIG. 6B may be implemented by the structure as shown in FIG. 5C, where the controllable display storage is controlled by one roller motor. As shown in FIG. 6C, the control device (not shown) is controlled such that the bottom part of the control device is in the opaque mode and the top part of the control device is in the transparent mode. Thus, the customer may see the information 624 and 626 (the text 624 and the sushi picture 626) on the bottom side of the transparent display panel 620, and the items 614 (the top half of the sushi plate) on the top side of the transparent display panel 620. As shown in FIG. 6D, the control device (not shown) is controlled such that the upper left and bottom right parts of the control device are in the opaque mode and the middle part of the control device is in the transparent mode. Thus, the customer may see the information 622 (the text) on the upper left side of the transparent display panel 620, the information 626 (the sushi picture) on the bottom right side of the transparent display panel 620, and the items 614 (the major part of the sushi plate and the left half of the bowl) on the middle part of the transparent display panel 620.

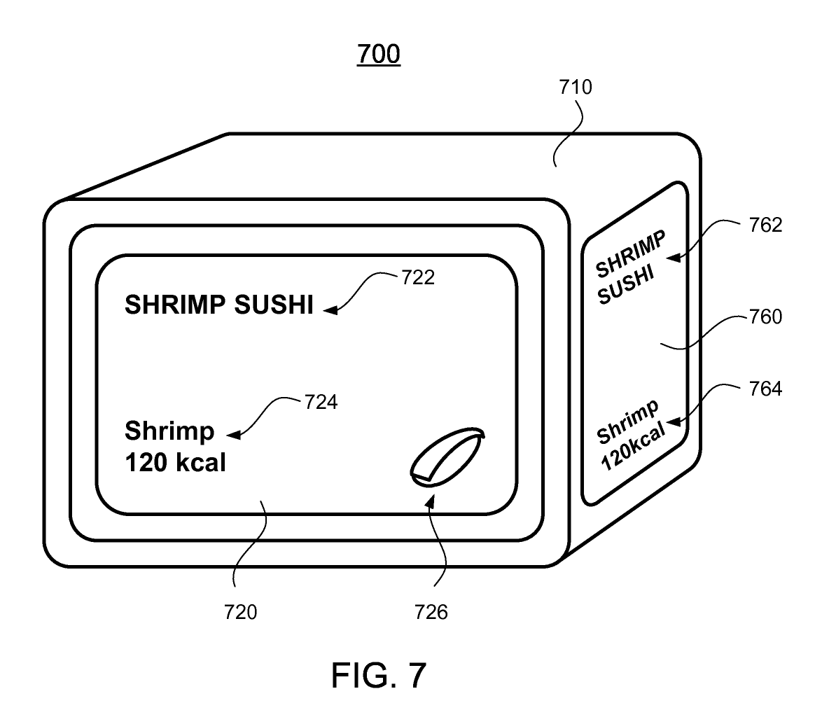

It should be appreciated that the controllable display storage may include at least one opening, where each opening is provided with a controllable display apparatus. For example, FIG. 7 shows schematically a perspective view of a controllable display storage according to one embodiment of the disclosure, where the controllable display storage 700 has two controllable display apparatuses. Specifically, on the front side of the controllable display storage 700, a transparent display panel 720 is provided, showing the information 722, 724 and 726. On the right side of controllable display storage 700, another transparent display panel 760 is provided, showing the information 762 and 764. Although not shown in FIG. 7, a plurality of the control device may be provided to correspond to the transparent display panel 720 and the transparent display panel 760 respectively. In certain embodiments, one control device may be provided for both the transparent display panel 720 and the transparent display panel 760, where the control device has a plurality of control regions respectively corresponding to the transparent display panel 720 and the transparent display panel 760.

In sum, aspects of the disclosure, among other things, recite controllable display apparatuses and applications thereof. In one embodiment, the controllable display apparatus may be switchable such that a viewer may see the information displayed on the transparent display panel or the items behind the controllable display apparatus. It should be appreciated that the use of the controllable display apparatus is not restricted to the display storages. For example, the controllable display apparatus may be used as an individual display device or in combination with other display devices, such that the display device may be switchable to show two sets of different screen information.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A controllable display storage, comprising:
a storage having a storage space therein and an opening exposing the storage space to an outer environment;
a transparent display panel disposed at the opening, defining a viewer side facing the outer environment and a control side facing the storage space, configured to display information thereon; and
a control device disposed at the control side of the transparent display panel between at least a part of the storage space and the transparent display panel, wherein at least a part of the control device is switchable between a plurality of control modes, wherein the plurality of control modes comprises a transparent mode and an opaque mode.

2. The controllable display storage of claim 1, being a display window, a display box or a display cabinet.

3. The controllable display storage of claim 1, further comprising:
at least one light source disposed in the storage space to provide light to the storage space.

4. The controllable display storage of claim 1, wherein the control device comprises an electrically controlled liquid crystal glass or an electrically controlled liquid crystal film.

5. The controllable display storage of claim 3, wherein the plurality of control modes further comprises a semi-transparent mode such that the information displayed on the transparent display panel and the item at the control side are concurrently viewable from the viewer side when the control device is in the semi-transparent mode.

6. The controllable display storage of claim 3, wherein the control device comprises a plurality of control regions thereon, wherein each control region is individually switchable between the plurality of control modes.

7. The controllable display storage of claim 1, wherein the control device is a screen movable between a first position and a second position, wherein the control device is in the transparent mode when the control device moves to the first position, and in the opaque mode when the control device moves to the second position.

8. The controllable display storage of claim 6, further comprising:
at least one roller motor connected to the control device for moving the control device between the first position and the second position.

9. The controllable display storage of claim 1, wherein the control device corresponds to at least a portion of the transparent display panel.

10. A controllable display storage, comprising:
a storage having a storage space therein and at least one opening exposing the storage space to an outer environment; and
at least one controllable display apparatus disposed at the at least one opening respectively, wherein each controllable display apparatus comprises:
a transparent display panel defining a viewer side and a control side facing the storage space, configured to display information thereon; and
a control device disposed at the control side of the transparent display panel between at least a part of the storage space and the transparent display panel, wherein at least a part of the control device is switchable between a plurality of control modes, wherein the plurality of control modes comprises a transparent mode and an opaque mode, such that the information displayed on the transparent display panel is viewable from the viewer side when the control device is in the opaque mode, and an item displayed in the storage space is viewable from the viewer side through the transparent display panel when the control device is in the transparent mode.

11. The controllable display storage of claim 9, further comprising:
at least one light source disposed in the storage space to provide light to the storage space.

12. The controllable display storage of claim 9, wherein the control device comprises an electrically controlled liquid crystal glass or an electrically controlled liquid crystal film.

13. The controllable display storage of claim 11, wherein the control device comprises a plurality of control regions thereon, wherein each control region is individually switchable between the plurality of control modes.

14. The controllable display storage of claim 9, wherein the control device is a screen movable between a first position and a second position, wherein the control device is in the transparent mode when the control device moves to the first position, and in the opaque mode when the control device moves to the second position.

15. The controllable display storage of claim 13, further comprising:
at least one roller motor connected to the control device for moving the control device between the first position and the second position.

16. The controllable display storage of claim 9, wherein the control device corresponds to at least a portion of the transparent display panel.

17. A controllable display apparatus, comprising:
a transparent display panel defining a viewer side and a control side, configured to display information thereon; and
a control device disposed at the control side of the transparent display panel, wherein at least a part of the control device is switchable between a plurality of control modes, wherein the plurality of control modes comprises a transparent mode and an opaque mode, such that the information displayed on the transparent display panel is viewable from the viewer side when the control device is in the opaque mode, and an item at the control side is viewable from the viewer side through the transparent display panel when the control device is in the transparent mode.

18. The controllable display apparatus of claim 16, wherein the control device comprises an electrically controlled liquid crystal glass or an electrically controlled liquid crystal film.

19. The controllable display apparatus of claim 16, wherein the plurality of control modes further comprises a semi-transparent mode such that the information displayed on the transparent display panel and the item at the control side are concurrently viewable from the viewer side when the control device is in the semi-transparent mode.

20. The controllable display apparatus of claim 16, wherein the control device comprises a plurality of control regions thereon, wherein each control region is individually switchable between the plurality of control modes.
